(19) United States
(12) Patent Application Publication
(10) Pub. No.: US 2015/0137767 A1
(43) Pub. Date: May 21, 2015

(54) PROTECTION APPARATUS FOR RECHARGEABLE BATTERY

(71) Applicant: Samsung SDI Co., Ltd., Yongin-si (KR)

(72) Inventor: Duk-Jung Kim, Yongin-si (KR)

(21) Appl. No.: 14/539,938

(22) Filed: Nov. 12, 2014

(30) Foreign Application Priority Data
Nov. 20, 2013 (KR) 10-2013-0141456

(51) Int. Cl. H02J 7/00

(52) U.S. Cl. CPC H02J 7/0031; H02J 2007/0037
USPC 320/137

(57) ABSTRACT

The described technology relates to a protection apparatus for a rechargeable battery. An example embodiment provides a protection apparatus for a rechargeable battery including a battery unit coupled to a charger through first and second external ports and including a plurality of unit cells charged by receiving a charging current from the charger. The example embodiment also includes a relay for blocking the charging current that is supplied to the battery unit, and a connection portion that deforms according to an internal pressure of the battery unit to electrically connect the battery unit and the relay.

### CROSS-REFERENCE TO RELATED APPLICATION

This application claims priority to and the benefit of Korean Patent Application No. 10-2013-0141456 filed in the Korean Intellectual Property Office on Nov. 20, 2013, the entire contents of which are incorporated herein by reference.

### BACKGROUND

1. Field

The described technology relates generally to a protection apparatus of a rechargeable battery. More particularly, the described technology relates to a protection apparatus for preventing an overcharge of a rechargeable battery.

2. Description of the Related Art

A rechargeable battery can be charged and discharged repeatedly, and can be, for example, a nickel-hydrogen (Ni-MH) battery and/or a lithium (Li) ion battery. The rechargeable battery is used as an energy source for a mobile device, an electric vehicle, a hybrid vehicle, and an electric device, and can have various shapes according to a kind of the devices.

A low-capacity rechargeable battery is used for small portable electronic devices such as cellular phones, notebook computers, and camcorders, and a large-capacity rechargeable battery may be used as a power supply for driving a motor for a hybrid car, etc.

The rechargeable battery is used as a single cell, like in a small-sized electronic device, or may be used in a module state in which a plurality of cells for driving a motor are electrically coupled, or in a pack state in which a plurality of modules are electrically coupled.

When the rechargeable battery is abnormally overcharged, an inner voltage of the rechargeable battery is increased such that gas is generated. The internal pressure is increased by the generated gas such that a case of the rechargeable battery may expand and explode. Accordingly, a protection apparatus for preventing the abnormal overcharging of the rechargeable battery is required.

### SUMMARY

An example embodiment provides a protection apparatus for a rechargeable battery for preventing an abnormal overcharge thereof.

A protection apparatus for a rechargeable battery according to a first aspect may include a battery unit coupled to a charger through a first external port and a second external port, the battery unit including a plurality of unit cells to be charged by a charging current from the charger, a relay for blocking the charging current supplied to the battery unit, and a connection portion to electrically couple the battery unit and the relay, the connection portion being adapted to be deformed according to an internal pressure of the battery unit.

The relay may include a switch having a first terminal coupled to an external port and a second terminal coupled to a first electrode of a unit cell from among the plurality of unit cells, and a coil having a first terminal coupled to the connection portion and a second terminal coupled to a second electrode of a unit cell from among the plurality of unit cells, the coil being adapted to drive the switch by receiving a voltage from the first electrode and the second electrode as a driving voltage through the connection portion.

Each of the plurality of unit cells may include an electrode assembly including the first electrode and the second electrode, and a case containing the electrode assembly.

The connection portion may include a first shorting plate integrally formed with at least one case from among a plurality of unit cells, the first shorting plate being deformed according to an internal pressure of the at least one case, and being electrically coupled to the first electrode, and a second shorting plate separated from the first shorting plate and electrically coupled to the first terminal of the coil, and the second shorting plate adapted to physically contact the first shorting plate when the first shorting plate is deformed.

The second shorting plate may be insulated from the case and formed outside of the case.

A protection apparatus for a rechargeable battery according to another aspect may include a battery unit coupled to a charger through a first external port and a second external port, the battery unit including a plurality of battery modules to be charged by a charging current from the charger, a relay for blocking the charging current supplied to the battery unit, and a connection portion to electrically couple the battery unit and the relay, the connection portion to be deformed according to an internal pressure of the battery unit.

The relay may include a switch having a first terminal coupled to the external port and a second terminal coupled to a first electrode of a battery module of the plurality of battery modules, and a coil having a first terminal coupled to the connection portion and a second terminal coupled to a second electrode of a battery module of the plurality of battery modules, the coil being adapted to drive the switch by receiving a voltage from the first electrode and the second electrode as a driving voltage through the connection portion.

Each of the plurality of battery modules may include a plurality of unit cells respectively including an electrode assembly having the first electrode and the second electrode, a case containing the electrode assembly, and a module case containing the plurality of unit cells.

The at least one connection portion may be formed among a plurality of unit cells included in at least one battery module from among the plurality of battery modules.

The protection apparatus may also include a first shorting plate integrally formed with a case of at least one unit cell, the first shorting plate being deformed according to an internal pressure of the case, and being electrically coupled to the first electrode, and a second shorting plate separated from the first shorting plate and electrically coupled to the first terminal of the coil, and the second shorting plate adapted to physically contact the first shorting plate when the first shorting plate is deformed.

The second shorting plate may be formed on at least one module case from among the plurality of battery modules.

### BRIEF DESCRIPTION OF THE DRAWINGS

FIG. 1 is a circuit diagram of a protection apparatus for a rechargeable battery according to an example embodiment.

FIG. 2 is a view showing an operation of the protection apparatus for the rechargeable battery according to an example embodiment.

FIG. 3 is a schematic diagram of the protection apparatus for the rechargeable battery shown in FIG. 1.

FIG. 4 is a detailed schematic diagram of a connection portion 20 shown in FIG. 3.

FIG. 5 is a circuit diagram of a protection apparatus for a rechargeable battery according to another example embodiment.

FIG. 6 is a schematic diagram of the protection apparatus for the rechargeable battery shown in FIG. 5.

FIG. 7 is a detailed schematic diagram of a connection portion 200 shown in FIG. 6.

### DETAILED DESCRIPTION

In the following detailed description, certain example embodiments are shown and described. As those having ordinary skill in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the words “comprise” and “include,” and variations such as “comprises” “comprising,” “includes,” and “including” will be understood to imply the inclusion of stated elements but not the exclusion of any other elements.

Example embodiments that can be realized by a person skilled in the art will now be described with reference to drawings.

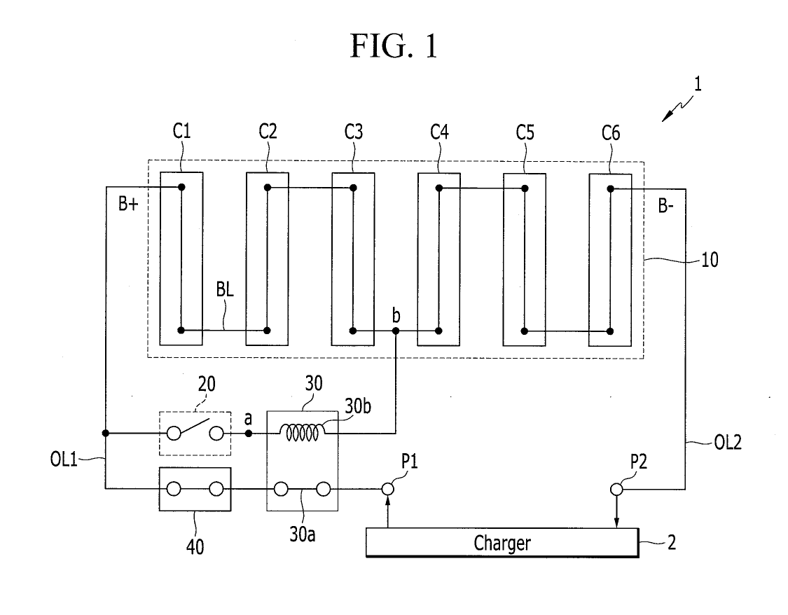

FIG. 1 is a circuit diagram of a protection apparatus for a rechargeable battery according to an example embodiment.

Referring to FIG. 1, the protection apparatus for a rechargeable battery 1 according to an example embodiment includes a battery unit 10, a connection portion 20, a relay 30, and a fuse 40. The battery unit 10 shown in FIG. 1 is a rechargeable battery module, and is coupled to a charger 2 through external ports P1 and P2 to be charged. The battery unit 10 is coupled to an external load through the external ports P1 and P2 to be discharged.

The battery unit 10 includes first to sixth unit cells C1-C6 coupled in series. B+ and B− shown in FIG. 1 represent a positive terminal and a negative terminal, respectively, of the first to sixth unit cells C1-C6. Here, the battery unit 10 includes six unit cells C1-C6, however, the embodiments of the present invention are not limited thereto, and the number of the unit cells may be changed.

The positive terminal of one unit cell among the first to sixth unit cells C1-C6 is coupled to the negative terminal of an adjacent unit cell through a bus bar BL. Also, the positive terminal of the first unit cell C1 and the negative terminal of the sixth unit cell C6 are respectively coupled to the external power source lines OL1 and OL2. The first to sixth unit cells C1-C6 receive a charging current flowing through the external power source lines OL1 and OL2 to charge (e.g. charge a predetermined voltage).

The connection portion 20 selectively transmits a driving voltage to the relay 30 according to a charge state of the battery unit 10. Here, the connection portion 20 forms a physical conductive line electrically coupling one positive terminal among the first to sixth unit cells C1-C6 and the relay 30.

In more detail, the connection portion 20 acts as the conductive line that is physically decoupled when the battery unit 10 is in a normal charge state, and the connection portion 20 acts as the conductive line that is physically coupled when the battery unit 10 is in an abnormal overcharge state.

The connection portion 20 may be coupled to at least one unit cell among the first to sixth unit cells C1-C6. Hereinafter, the connection portion 20 is described as being coupled to the first unit cell C1, however, the present invention is not limited thereto, and a position and/or the number of connection portions 20 may vary.

The relay 30 receives the driving voltage through the connection portion 20 to selectively block the charging current supplied to the first to sixth unit cells C1-C6. Here, the driving voltage of the relay 30 is guided from each cell voltage of the first to sixth unit cell C1-C6. For example, when the driving voltage of the relay 30 is 12 V and each cell voltage of the first to sixth unit cells C1-C6 is 4 V, the relay 30 may be driven with the cell voltage of the first to third unit cells C1-C3.

When the connection portion 20 acts as the physically decoupled conductive line, the relay 30 electrically couples the charger 2 and the external power source lines OL1 and OL2. Also, when the connection portion 20 acts as the physically coupled conductive line, the relay 30 electrically decouples the connection between the charger 2 and the external power source lines OL1 and OL2. That is, the charging current supplied to the first to sixth unit cells C1-C6 is blocked by the driving of the relay 30.

The relay 30 includes a switch 30a and a coil 30b for turning ON/OFF the switch 30a. The switch 30a is coupled between the external power source line OL1 and the external port P1. The coil 30b includes a connection point a (or node a) coupled to the connection portion 20 and a connection point b (or node b) coupled to a bus line BL between the third unit cell C3 and the fourth unit cell C4. However, the position of the node b may be changed according to the driving voltage and the cell voltage of the relay 30. The fuse 40 is coupled between the external power source line OL1 and the switch 30a.

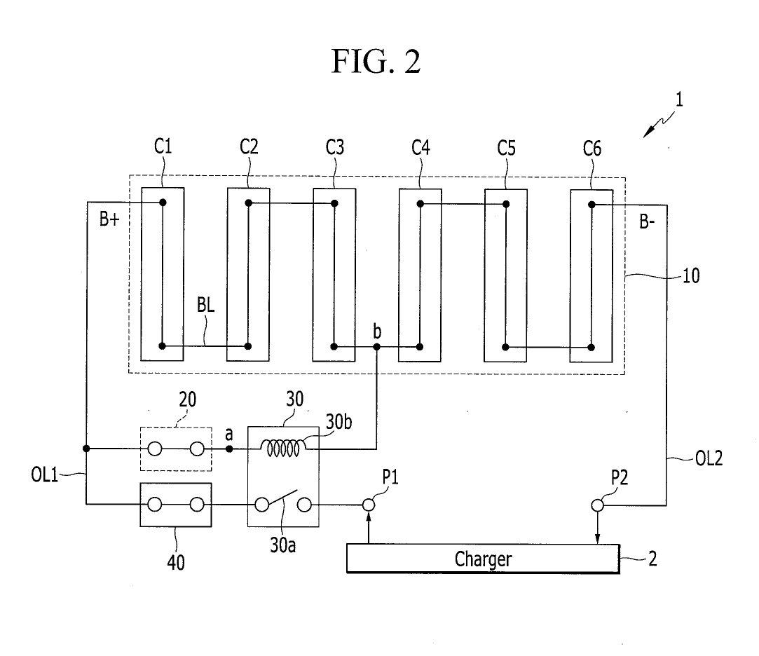

An operation of the example protection apparatus for the rechargeable battery as described above will be described with reference to FIG. 2.

FIG. 2 is a view to explain an operation of a protection apparatus for a rechargeable battery according to an example embodiment.

First, when the battery unit 10 is in a normal charge state, the connection portion 20 acts as the physically decoupled conductive line (i.e., open circuit), as shown in FIG. 1. During this time, the switch 30a of the relay 30 is in the ON state (i.e. closed switch).

Accordingly, if the charger 2 is coupled through the external ports P1 and P2, the charging current flowing through the external power source lines OL1 and OL2 is supplied to the first to sixth unit cells C1-C6. Thus, the voltage (e.g., voltage of a predetermined level) is charged to the first to sixth unit cells C1-C6.

In this state, if the battery unit 10 is abnormally overcharged such that the internal pressure is increased, the connection portion 20 acts as the physically coupled conductive line by the internal pressure.

Thus, the driving voltage is supplied to the relay 30, and the switch 30a is converted into the OFF state (i.e., opened switch) by the coil 30b of the relay 30, as shown in FIG. 2. Accordingly, the charging current flowing to the external power source lines OL1 and OL2 is blocked, and the charging of the first to sixth unit cells C1-C6 is stopped.

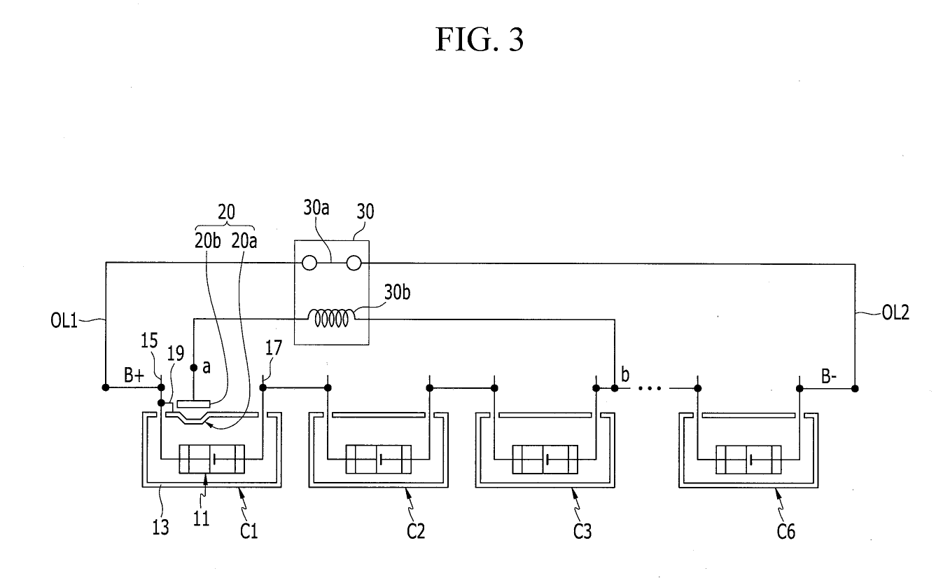

FIG. 3 is a schematic diagram of the protection apparatus for the rechargeable battery shown in FIG. 1, showing a coupling relationship between the battery unit 10, the connection portion 20, and the relay 30.

Referring to FIG. 3, the first to sixth unit cells C1-C6 are arranged in one direction with a space (e.g., a predetermined space or interval) therebetween. The first to sixth unit cells C1-C6 according to an example embodiment, respectively, have a general structure that includes an electrode assembly 11 in which a positive electrode plate and a negative electrode plate have a separator interposed therebetween.

Here, the first to sixth unit cells C1-C6 are lithium ion secondary batteries, and have a rectangular shape. However, the example embodiment is not limited thereto, and the batteries may have various shapes and types such as a lithium polymer battery or a cylindrical battery.

According to an embodiment, the electrode assembly 11 is housed in a case 13, and includes a positive terminal 15 and a negative terminal 17 that protrude outside of the case 13. The positive terminal 15 and the negative terminal 17 may be formed as having a bolt shape such that screw threads may be formed in an external circumferential surface. The case 13 may be formed of a metal such as aluminum or stainless steel.

According to an embodiment, the connection portion 20 is on the first unit cell C1, and includes a first shorting plate 20a and a second shorting plate 20b. The first shorting plate 20a has a convex shape that faces an inward direction of the case 13 such that the convex shape may become inverted by the internal pressure of the case 13.

Here, the first shorting plate 20a is electrically coupled to the positive terminal 15 of the first unit cell C1 through a connection tab 19. The connection tab 19 may be extended from the positive terminal 15, and a shape thereof is not limited to that shown in FIG. 3.

According to the described embodiment, the second shorting plate 20b faces the first shorting plate 20a and is separated from the first shorting plate 20a. The second shorting plate 20b is electrically coupled to the relay 30.

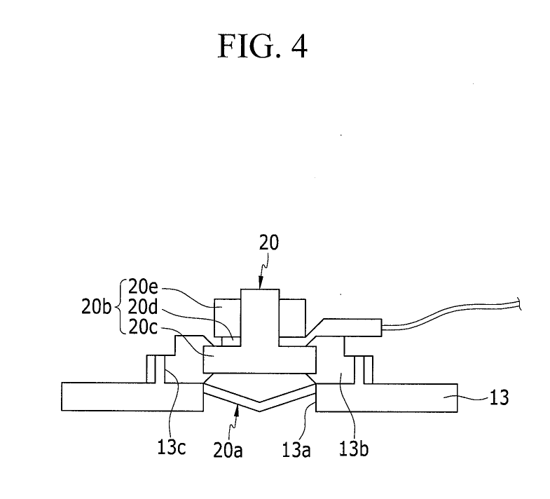

FIG. 4 is a detailed schematic diagram of the connection portion 20 shown in FIG. 3.

Referring to FIG. 4, the connection portion 20 includes the first shorting plate 20a and the second shorting plate 20b. The first shorting plate 20a is integrally formed with the case 13 and is located at a shorting hole (or opening) 13a of the case 13.

The second shorting plate 20b is also located at the shorting hole (or opening) 13a of the case 13, and separated from the first shorting plate 20a. Here, the second shorting plate 20b includes a bolt 20c, a ring terminal 20d, and a nut 20e.

According to the embodiment, the bolt 20c is partially buried in an insulator 13b by an insert molding that is fixed to the case 13. The insulator 13b is formed on the case 13, and includes a through hole at a position corresponding to the shorting hole 13a. The case 13 may include a fixing tab 13c for fixing the insulator 13b. The bolt 20c is physically coupled with the first shorting plate 20a and electrically couples the first shorting plate 20a to the ring terminal 20d.

The ring terminal 20d is coupled to the bolt 20c and is electrically coupled to the relay 30 through a wire that is pressed and coupled to an end thereof. The nut 20e is coupled to the bolt 20c to fix the ring terminal 20d.

That is, according to the described embodiment, the convex shape of the first shorting plate 20a is inverted by the internal pressure of the case 13 (e.g., when the internal pressure increases) and becomes physically coupled with the bolt 20c. Thus, the first shorting plate 20a is electrically coupled to the relay 30 through the wire of the ring terminal 20d.

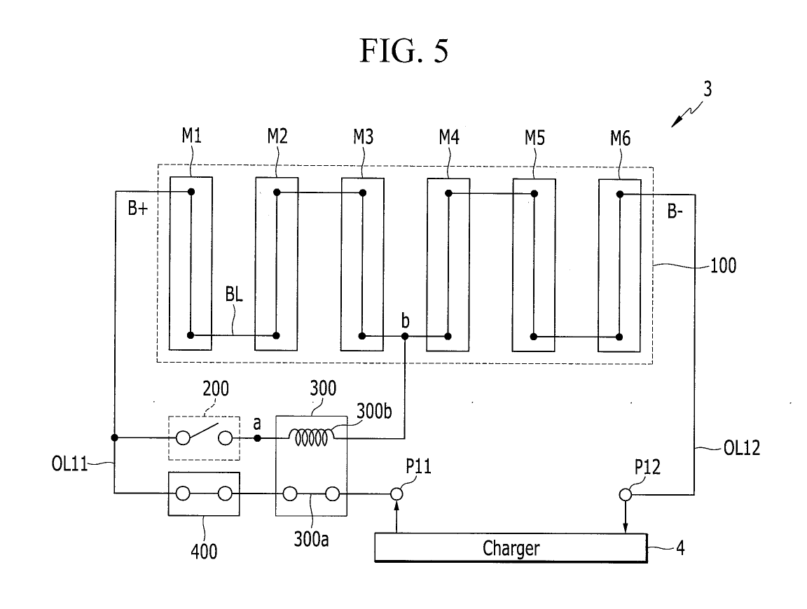

FIG. 5 is a circuit diagram of a protection apparatus for a rechargeable battery according to another example embodiment.

Referring to FIG. 5, a protection apparatus for the rechargeable battery 3 according to another example embodiment includes a battery unit 100, a connection portion 200, a relay 300, and a fuse 400. The battery unit 100 shown in FIG. 5 shows a rechargeable battery pack including first to sixth battery modules M1-M6, and is coupled to a charger 4 through external ports P11 and P12 to be charged.

The first to sixth battery modules M1-M6 are coupled in series, and the positive terminal of the first battery module M1 and the negative terminal of the sixth battery module M6 are respectively coupled to the external power source lines OL11 and OL12. The first to sixth battery modules M1-M6 receive the charging current flowing through the external power source lines OL11 and OL12 to charge the predetermined voltage.

The connection portion 200 selectively transmits the driving voltage to the relay 300 according to the charge state of the battery unit 100. Here, the connection portion 200 acts as a physical conductive line for electrically coupling one positive terminal among the first to sixth battery modules M1-M6 to the relay 30. For example, the connection portion 200 is on with the first battery module M1, and forms the physical conductive line connecting the positive terminal of the first battery module M1 and the relay 300.

The relay 300 receives the driving voltage through the connection portion 200 to selectively block the charging current supplied to the first to sixth battery modules M1-M6. The driving voltage of the relay 300 is guided from each module voltage of the first to sixth battery modules M1-M6. For example, when the driving voltage of the relay 300 is 36 V and each module voltage of the first to sixth battery modules M1-M6 is 12 V, the relay 300 may be driven with the module voltage of the first to third battery modules M1-M3.

When the connection portion 200 acts as a physically decoupled conductive line, the relay 300 electrically couples the charger 4 to the external power source lines OL11 and OL12. In some embodiments, when the connection portion 200 acts as the physically coupled conductive line, the relay 300 decouples the electrical coupling between the charger 4 and the external power source lines OL11 and OL12. That is, the charging current supplied to the first to sixth battery modules M1-M6 is blocked by the driving of the relay 300.

In some embodiments, the relay 300 includes a switch 300a and a coil 300b for turning ON/OFF the switch 300a. The switch 300a is coupled to the external power source line OL11 and the external port P11.

The coil 300b includes a connection point a coupled to the connection portion 200, and a connection point b coupled to a bus line BL between the third battery module M3 and the fourth battery module M4. The position of the node b may be changed according to the driving voltage of the relay 300 and the module voltage. The fuse 400 is coupled between the external power source line OL11 and the switch 300a.

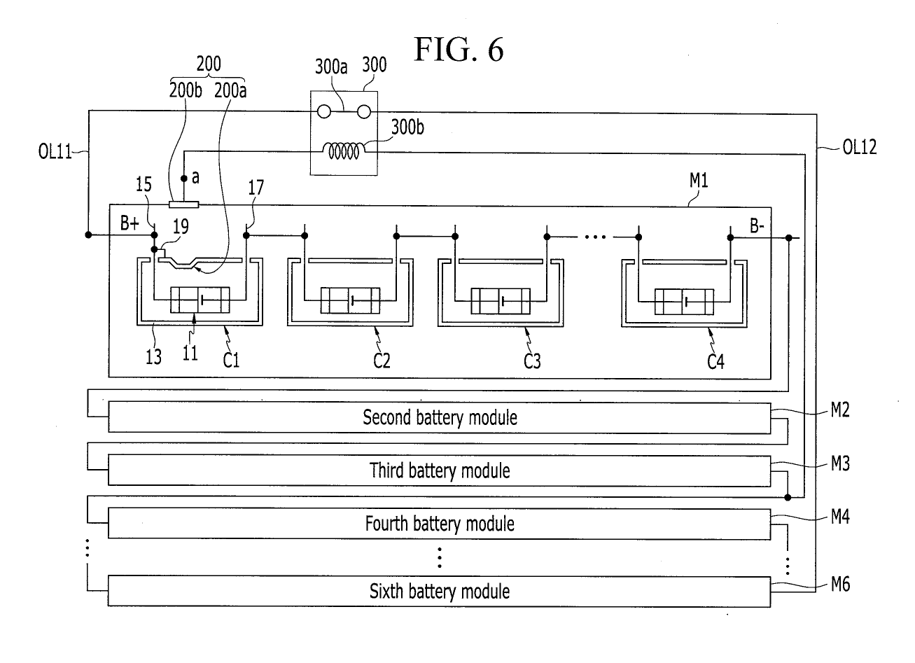

FIG. 6 is a schematic diagram of the protection apparatus for the rechargeable battery shown in FIG. 5, and shows the connection relationship between the battery unit 100, the connection portion 200, and the relay 300.

Referring to FIG. 6, the first to sixth battery modules M1-M6 respectively include the first to sixth unit cells C1-C6. The first to sixth unit cells C1-C6 are the same as those of FIG. 3 such that they are indicated by the same reference numerals, and the detailed description thereof is omitted.

The connection portion 200 on the first battery module MI includes first and second shorting plates 200a and 200b. Here, the first shorting plate 200a may be arranged over at least one among the first to sixth unit cells C1-C6 in the first battery module Ml, for example the first unit cell C1.

The first shorting plate 200a is has a convex shape in an inward direction of the case 13, and the shape thereof is inverted by the internal pressure of the case 13. Here, the first shorting plate 200a is electrically coupled to the positive terminal 15 of the first unit cell C1 through the connection tab 19. The connection tab 19 may extend from the positive terminal 15, and the shape thereof is not limited to the shape shown in FIG. 6.

In some embodiments, the second shorting plate 200b faces the first shorting plate 200a, and is located on the module case 110 of the first battery module M1. The second shorting plate 200b is electrically coupled to the relay 30. The relay 300 is located outside of the module case 110.

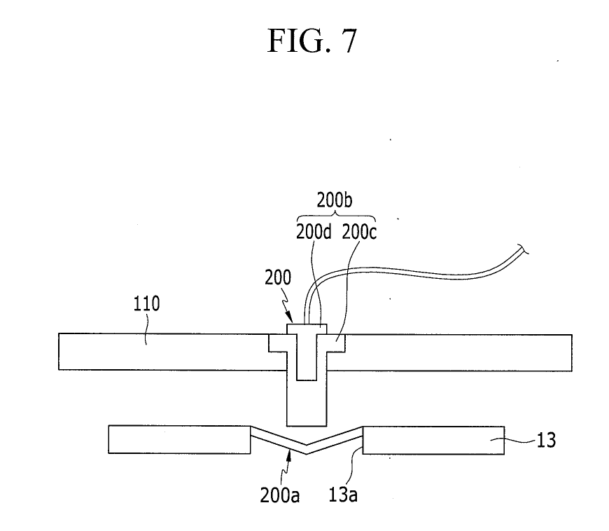

FIG. 7 is a detailed schematic diagram of the connection portion 200 shown in FIG. 6.

Referring to FIG. 7, the connection portion 200, according to some embodiments, includes the first and second shorting plates 200a and 200b. Here, the first shorting plate 200a is the same as the first shorting plate 20a shown in FIG. 4 such that the detailed description thereof is omitted.

The second shorting plate 200b is separated from the first shorting plate 200a at the shorting hole 13a of the case 13. In some embodiments, the second shorting plate 200b includes a bolt 200c and a contact pin 200d. The bolt 200c is inserted and fixed on the module case 110. The module case 110 may include a through hole at the position that corresponds to the shorting hole (or opening) 13a.

In some embodiments, the contact pin 200d is inserted into the bolt 200c in a press-fit manner. The contact pin 200d may include an action pin that is mechanically inserted and fixed to the bolt 200c by using elasticity. The contact pin 200d is electrically coupled to the relay 300 through a wire that is pressed and coupled to the end thereof.

That is, the convex shape of the first shorting plate 200a is inverted by the internal pressure of the case 13 to physically contact the bolt 200c. Thus, the conductive line that is electrically coupled to the relay 300 through the wire of the contact pin 200d is realized.

As described above, the protection apparatus for the rechargeable battery according to an example embodiment may not only prevent overcharging of the battery under an abnormal state by control of a general battery management system (BMS), but may also physically block the charging current from being supplied to the rechargeable battery from the charger.

Also, by arranging the relay to block the charging current to the external power source line between the charger and the rechargeable battery and driving the relays 30 and 300 by using the cell voltage or the module voltage, overcharging may be prevented through the packaging unit such as the rechargeable battery module or the rechargeable battery pack.

Also, to generally prevent overcharging, in a case of using a current interruption device (CID) to block each current path of a plurality of unit cells by the internal pressure or an overcharge safety device (OSD) forming the conductive line bypassing the current path, the amount of parts comprising the unit cell is increased and the strength of the unit cell is weakend. Also, in the case of applying the OSD to the unit cell, the current path is bypassed such that the fuse is decoupled by guiding a large current to the fuse that is installed inside the unit cell such that performance is deteriorated by a trade-off between the OSD and the fuse.

Contrarily, the described example embodiments form the conductive line to apply the cell voltage or the module voltage from one unit cell in the battery module or the battery pack to the relay such that a design margin of the unit cell and the strength may be obtained, and a mechanical and structural interference with the system is generated.

While this disclosure is described in connection with what is presently considered to be practical example embodiments, it is to be understood that the invention is not limited to the disclosed embodiments, but, to the contrary, it is intended to cover various modifications and equivalent arrangements included within the spirit and scope of the appended claims, and their equivalents.

What is claimed is:

1. A protection apparatus for a rechargeable battery comprising:
a battery unit coupled to a charger through a first external port and a second external port, the battery unit including a plurality of unit cells to be charged by a charging current from the charger;
a relay for blocking the charging current supplied to the battery unit; and
a connection portion to electrically couple the battery unit and the relay, the connection portion being adapted to be deformed according to an internal pressure of the battery unit.

2. The protection apparatus of claim 1, wherein the relay comprises:
a switch having a first terminal coupled to an external port and a second terminal coupled to a first electrode of a unit cell from among the plurality of unit cells; and
a coil having a first terminal coupled to the connection portion and a second terminal coupled to a second electrode of a unit cell from among the plurality of unit cells, the coil being adapted to drive the switch by receiving a voltage from the first electrode and the second electrode as a driving voltage through the connection portion.

3. The protection apparatus of claim 2, wherein each of the plurality of unit cells comprises:
an electrode assembly comprising the first electrode and the second electrode; and
a case containing the electrode assembly.

4. The protection apparatus of claim 3, wherein the connection portion comprises:
a first shorting plate integrally formed with at least one case from among a plurality of unit cells, the first shorting plate being deformed according to an internal pressure of the at least one case, and being electrically coupled to the first electrode; and
a second shorting plate separated from the first shorting plate and electrically coupled to the first terminal of the coil, and the second shorting plate adapted to physically contact the first shorting plate when the first shorting plate is deformed.

5. The protection apparatus of claim 4, wherein the second shorting plate is insulated from the case and formed outside of the case.

6. A protection apparatus for a rechargeable battery comprising:
a battery unit coupled to a charger through a first external port and a second external port, the battery unit comprising a plurality of battery modules to be charged by a charging current from the charger;
a relay for blocking the charging current supplied to the battery unit; and
a connection portion to electrically couple the battery unit and the relay, the connection portion to be deformed according to an internal pressure of the battery unit.

7. The protection apparatus of claim 6, wherein the relay comprises:
a switch having a first terminal coupled to the external port and a second terminal coupled to a first electrode of a battery module of the plurality of battery modules; and
a coil having a first terminal coupled to the connection portion and a second terminal coupled to a second electrode of a battery module of the plurality of battery modules, the coil being adapted to drive the switch by receiving a voltage from the first electrode and the second electrode as a driving voltage through the connection portion.

8. The protection apparatus of claim 7, wherein each of the plurality of battery modules comprises:
a plurality of unit cells respectively including an electrode assembly having the first electrode and the second electrode;
a case containing the electrode assembly; and
a module case containing the plurality of unit cells.

9. The protection apparatus of claim 8, wherein at least one connection portion is formed among a plurality of unit cells included in at least one battery module from among the plurality of battery modules.

10. The protection apparatus of claim 9, further comprising:
a first shorting plate integrally formed with a case of at least one unit cell, the first shorting plate being deformed according to an internal pressure of the case, and being electrically coupled to the first electrode; and
a second shorting plate separated from the first shorting plate and electrically coupled to the first terminal of the coil, and the second shorting plate adapted to physically contact the first shorting plate when the first shorting plate is deformed.

11. The protection apparatus of claim 10, wherein the second shorting plate is formed on at least one module case from among the plurality of battery modules.
